(19) United States
(12) Patent Application Publication
(10) Pub. No.: US 2013/0090164 A1
(43) Pub. Date: Apr. 11, 2013

(54) Gaming with Dual Game Play

(71) Applicant: Martin Paul Moshal, Queens Way Quay (GI)

(72) Inventor: Martin Paul Moshal, Queens Way Quay (GI)

(73) Assignee: WATERLEAF LIMITED

(21) Appl. No.: 13/351,736

(22) Filed: Jan. 17, 2012

(30) Foreign Application Priority Data
Oct. 7, 2011 (GB) 1117329.1

(51) Int. Cl. A63F 13/00

(52) U.S. Cl. 463/31

(57) ABSTRACT

A computing device may be arranged to support a multiple-screen user-interface, and various controls to facilitate the assignment of applications to these screens. For instance, the computing device and the multiple-screen user interface may be part of a gaming device that allows the user to play one instance game on one of the screens, and either another instance of the same game, or an instance of a different game, on another of the screens. The controls may facilitate the user initiating games, moving the games between screens, and exiting games. Further, the controls may allow the user to place one or more of the games in autoplay mode, such that the game is played automatically for a pre-determined number of turns with pre-determined wagers made during each turn.

### BACKGROUND

Land-based gaming establishments, such as casinos and betting shops, generally have one or more freestanding gaming machines that can be used by players in order to play wagering games.

A gaming machine of this type may be configured to offer a single wagering game to a player, or may enable the player to select a game from a menu of two or more games that are available for play, one play at a time.

Further, such a gaming machine may be a standalone machine consisting of a processor, game software, and a random number generator (RNG), all of which are contained within a housing or cabinet, and which does not require network connectivity in order to operate. Alternatively, the gaming machine may be designed to function in a client/server topology in which the RNG is located in a remote gaming server that generates game results and delivers the results to the gaming machine. A processor in this alternative type of this gaming machine may execute game software to display a simulation of the game results to the player in an intelligible manner. This alternative type of gaming machine uses network connectivity so as to communicate with the gaming server.

Traditionally, gaming machines are supplied to a gaming establishment already configured with game software and input/output peripherals such as buttons, note acceptors (bill validators), coin hoppers, tower lights and key switches, in accordance with the proprietor's requirements. The gaming machines are also configured with artwork and trade marks in accordance with the gaming establishment.

Gaming machines may have dual display screens, in vertical alignment. Usually, the simulation of the game takes place on the lower display screen, while the upper display screen is used for ancillary purposes such as, for example, displaying a game pay table, displaying game-specific trademarks and artwork, or displaying various video sequences to attract would-be players.

It is desirable to utilise the upper display screen of such gaming machines to provide players with enhanced game play functions and features.

### SUMMARY

In an example embodiment, an instance of a first application may be displayed on a screen of a multiple-screen user-interface. Perhaps while displaying the instance of the first application on the screen of the multiple-screen user-interface, it may be determined that no application instance is being displayed on at least one other screen of the multiple-screen user-interface. Potentially in response to at least determining that no application instance is being displayed on the at least one other screen of the multiple-screen user-interface, (i) an instance of a second application may be initiated, and (ii) the instance of the first application and the instance of the second application may be displayed on different screens of the multiple-screen user-interface.

In some embodiments, the first and second applications are the same application, while in other embodiments, the first and second applications are different applications. Regardless, the first and second applications may operate independently from one another.

Displaying the instance of the first application on a first screen and displaying the instance of the second application on a second screen may involve swapping application instances and screens so that the instance of the first application is displayed on the second screen and the instance of the second application is displayed on the first screen. In some embodiments, the multiple-screen user-interface may include a swap-screen control, and the application instances and screens may be swapped also in response to determining that the swap-screen control has been activated.

Alternatively or additionally, the instance of the first application may be displayed on a first screen. Displaying the instance of the first application and the instance of the second application on different screens of the multiple-screen user-interface may involve moving the display of the instance of the first application to a second screen, and displaying the instance of the second application on the first screen. In some embodiments, the multiple-screen user-interface may include a move control, and the display of the instance of the first application may be moved to the second screen in response to determining that the move control has been activated.

Generally speaking, each respective screen of the multiple-screen user-interface may be associated with a respective set of controls that impact behavior of the respective application displayed on the respective screen. Alternatively, a single screen of the multiple-screen user-interface may be associated with a set of controls that only impact behavior of an application displayed on the single screen, or a single screen of the multiple-screen user-interface may be associated with a set of controls that impact behavior of applications displayed on any screen of the multiple-screen user-interface.

In some embodiments, a given screen of the multiple-screen user-interface may be associated with an autoplay control. Operating the first application may involve performing a first sequence of turns with each turn in the first sequence performed according to a first parameter. If it is determined that the autoplay control has been activated for the first application, a specification of a first number of turns and a specification of the first parameter may be received. The first application may be automatically performed for the first number of turns, such that each respective turn is performed according to the first parameter.

Additionally, operating the second application may involve performing a second sequence of turns with each turn in the second sequence performed according to a second parameter. If it is determined that the autoplay control has been activated for the second application, a specification of a second number of turns and a specification of the second parameter may be received. The second application may be automatically performed for the second number of turns, such that each respective turn is performed according to the second parameter.

Further, performance of the second application for the second number of turns may begin before performance of the first application for the first number of turns ends.

Additionally, in any embodiment, the multiple-screen user-interface may be combined with a computing device so that the computing device comprises the multiple-screen user-interface. Alternatively, the multiple-screen user-interface and the computing device may be separate physical devices that communicate with one another (e.g., over a network). In either arrangement, the computing device may include a computer-readable medium containing instructions that, if executed, cause the computing device to perform any of the functions described above.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

Example embodiments of the invention are described herein with reference to the drawings, in which:

FIG. 1 illustrates an example gaming machine, in accordance with an example embodiment.

FIG. 2 illustrates example single game play on the gaming machine of FIG. 1, in accordance with an example embodiment.

FIG. 3 illustrates a transition of the gaming machine of FIG. 1 from single game play mode to dual game play mode, in accordance with an example embodiment.

FIG. 4 illustrates the gaming machine of FIG. 1 in dual game play mode with an open Dual Play Menu, in accordance with an example embodiment.

FIG. 5 is an illustration of example icons of the Dual Play Menu of FIG. 4, in accordance with an example embodiment.

FIG. 6 is a flow chart of steps to initiate, on the top display screen of the gaming machine of FIG. 4, a further instance of a currently-active game on the bottom display screen, in accordance with an example embodiment.

FIG. 7 is a further flowchart of the steps to initiate, on the top display screen of the gaming machine of FIG. 4, an instance of a different game to that currently active on the bottom display screen, in accordance with an example embodiment.

FIG. 8 is a flow chart of the steps to swap currently-active games on the top and bottom display screens, respectively, in accordance with an example embodiment.

FIG. 9 is a flow chart, in accordance with an example embodiment.

### DETAILED DESCRIPTION

### I. Example Gaming Machine

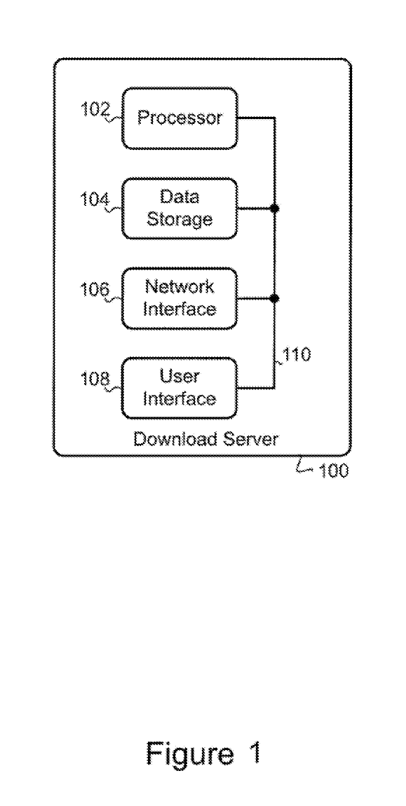

FIG. 1 depicts a gaming machine 100 in accordance with an example embodiment. Gaming machine 100 may be arranged as a server-based gaming machine. A server-based gaming machine may rely on a separate gaming server to perform certain gaming functions and to provide gaming results to the gaming machine. For example, a gaming server may include a random number generator (RNG) for use in performing a variety of games. Alternatively, gaming machine 100 may be arranged as a standalone gaming machine. A standalone gaming machine may include means for carrying out games. Such means may include a local RNG within gaming machine 100.

Gaming machine 100 may be arranged to allow a player to play any of a variety of games. For example, gaming machine 100 may be arranged to allow a player to play slot games, dice games, electronic scratch ticket-type games, or card games such as poker, blackjack or bridge. Other games a player can play using gaming machine 100 are also possible.

Gaming machine 100 may include a processor 102, data storage 104, a network interface 106, and a user interface indicated generally by reference numeral 108, all linked together via a system bus, network, or connection mechanism 110.

Processor 102 may comprise one or more processors. Processor 102 may arranged to carry out functions described herein, and may do so by executing program instructions and/or by interacting with data storage 104, network interface 106, user interface 108, and/or connection mechanism 110.

Data storage 104 may be a computer-readable medium. Data storage 104 may store various types of data. For example, data storage 104 may store program logic that is executable by processor 102. The program logic may be arranged such that, when executed, gaming machine 100 carries out certain functions as described herein.

As another example, data storage 104 may store gaming machine software files that correspond to gaming machine 100. In particular, data storage 104 may store the gaming machine software files that have been transmitted to gaming machine 100 from a download server (not shown) over a network.

Network interface 106 facilitates interfacing the gaming machine 100 to one or more networks. Network interface 106 may include a network interface card for interfacing to a wireless network and/or a wired network.

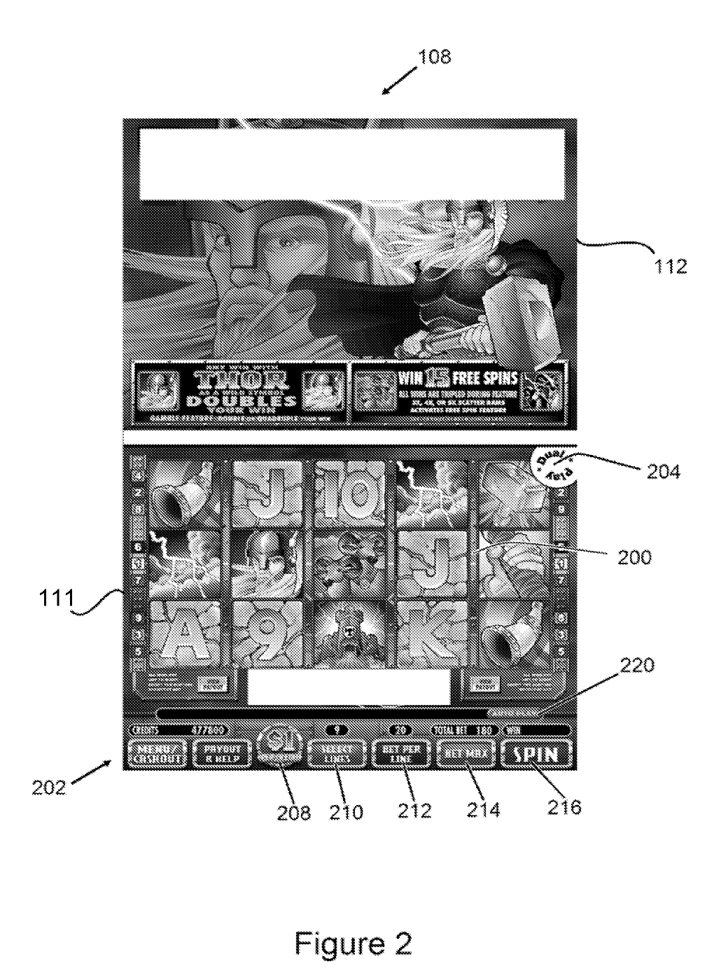

User interface 108 facilitates entering data into and/or receiving data from the gaming machine 100. User interface 108 may be arranged in various configurations. For example, user interface 108 may be arranged to have two display screens, namely, as shown in FIG. 2, bottom display screen 111 and top display screen 112, for displaying an attraction sequence of images, a sequence of images for playing a game, a games menu, and/or other images. As another example, user interface 108 may be arranged with a particular combination of knobs, buttons, and/or switches, for use in playing games, turning gaming machine 100 on or off, and a variety of other functions. Other examples of user interface 108 are also possible. In particular, the bottom display screen 111 could be a touch-sensitive display screen and some or all of the physical knobs, buttons and/or switches could be replaced by graphical icons on the bottom touch-sensitive display screen 111. Furthermore, the top display screen 112 could also be a touch-sensitive display screen with graphical icons that perform some or all of the above functions upon being touched.

### II. Single Game Play

Referring to FIG. 2, a representation of single game play on gaming machine 100 is illustrated. The illustrated game is a simulation of a video slot game 200 that is presented on the bottom display screen 111 of the user interface 108 of gaming machine 100. The top display screen 112 may display a static image or a sequence of images of game artwork and/or promotional messages relating to the game. The bottom display screen 111 may be touch-sensitive and the video slot game may include wager controls in the form of active graphical icons, indicated generally by reference numeral 202, that are used to play the game. The wager controls may include a Coins icon 208, a Select Lines icon 210, a Bet Per Line icon 212, a Bet Max icon 214 and a Spin icon 216. These icons are described in greater detail below.

The bottom display screen 111 also includes an icon 204 labelled “DUAL PLAY” and an icon 220 labelled “AUTO PLAY”, both of which will be discussed in detail in the description that follows.

### III. Dual Game Play

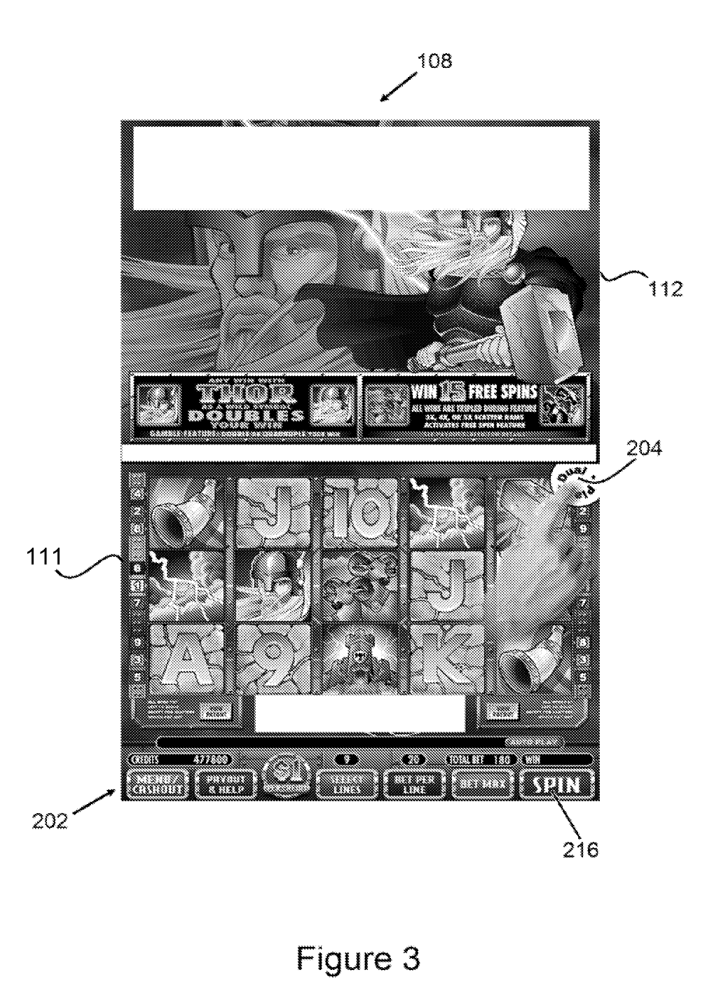

As shown in FIG. 3, a player may at any time during a playing session cause the gaming machine 100 to enter a dual game play mode by activating the DUAL PLAY icon 204 on the bottom display screen 111. In the dual game play mode the gaming machine 100 enables the player to undertake simultaneous game play of two distinct game instances.

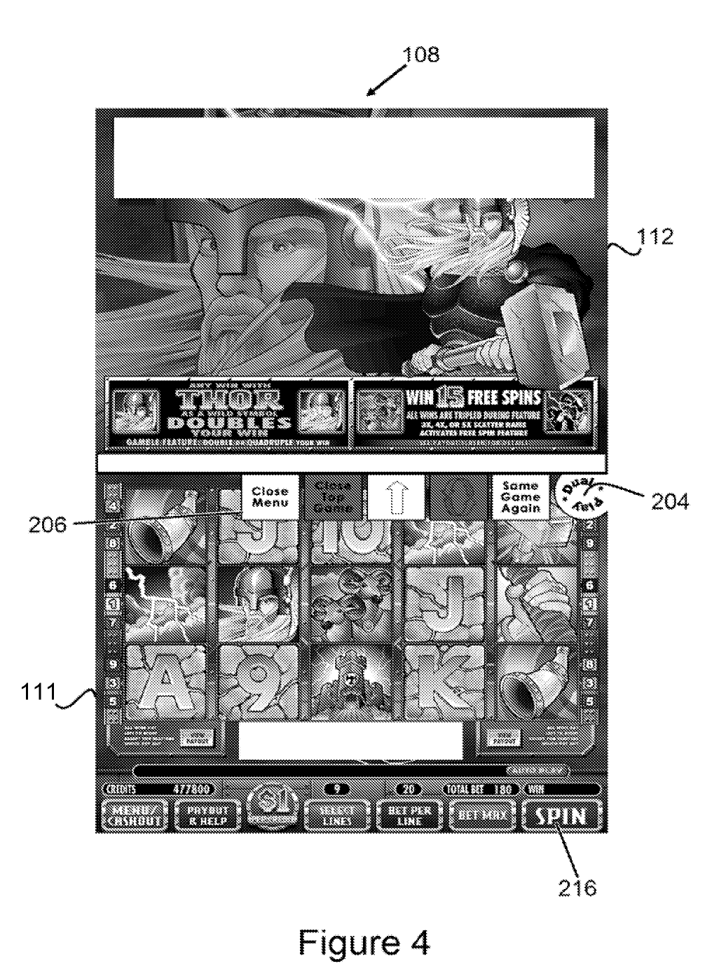

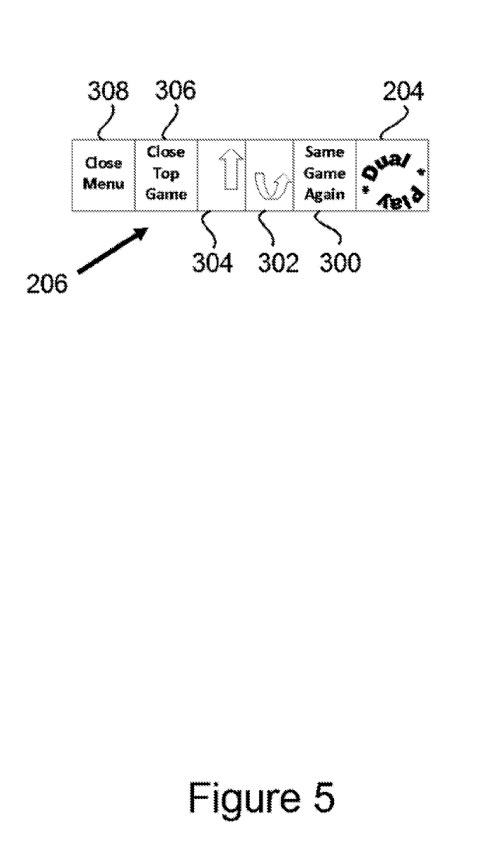

When the player activates the DUAL PLAY icon 204, A Dual Play Menu of active icons appears on the bottom display screen 111, indicated generally by reference numeral 206 and exemplified in FIG. 4. The Dual Play Menu 206 further is illustrated in FIG. 5 and may include the following icons:

A SAME AGAIN icon 300: activation of this icon will cause a further instance of a currently-active game on the bottom display screen 111 to initiate on the top display screen 112 as well, thereby allowing the player to play two different instances of the same game simultaneously.

A SWAP GAMES icon 302: activation of this icon will cause display of a currently-active instance of a game on the bottom display screen 111 to move to the top display screen 112. In addition, display of a currently-active instance of a game on the top display screen 112 will move to the bottom display screen 111.

A MOVE GAME UP icon 304: this icon will cause display of a currently-active instance of a game on the bottom display screen 111 to move to the top display screen 112. The effect of this icon is the same as that of the SWAP GAME icon 302 in the case when there is no currently-active instance of a game on the top display screen 112.

A CLOSE TOP GAME icon 306: activation of this icon causes an active instance of a game on the top display screen 112 to terminate, and the gaming machine 100 to return to single game play mode.

A CLOSE MENU icon 308: activation of this icon will cause the Dual Play Menu 206 on the bottom display screen 111 to close, and gaming machine 100 to remain in dual game play mode.

A. Replicating the Same Game

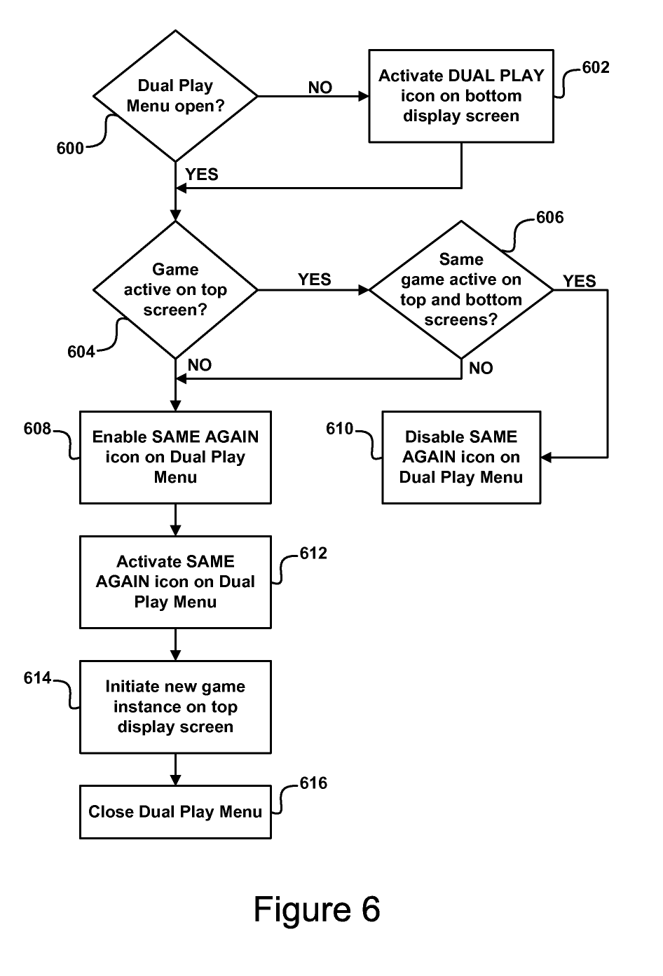

FIG. 6 is a flow chart depicting the steps that may be used to initiate on the top display screen 112, a further instance of a currently-active game on the bottom display screen 111.

The procedure commences with opening the Dual Play Menu 206, if not already open, by activating the DUAL PLAY icon 204 on the bottom display screen 111, as indicated at steps 600 and 602. If, at step 604, there is no active game instance on the top display screen 112, or there is an active game instance different to that on the bottom display screen 111, the SAME AGAIN icon 300 on the Dual Play Menu is enabled, as reflected at step 608. Alternatively, at step 606, if there is an active game instance on the top display screen 112 and the active game instances on the top and bottom display screens 112, 111 relate to the same game, the SAME AGAIN icon on the Dual Play Menu is disabled at step 610.

The player can activate the enabled SAME AGAIN icon 300 at step 612 to cause a separate instance of the currently-active game on the bottom display screen 111 to initiate on the top display screen 112 as well (step 614). If instances of two different games are already active on the top and bottom display screens 112, 111, the active game instance the top display screen 112 is replaced by an instance of the currently-active game on the bottom display screen 111. The active game instance on the bottom display screen 111 continues to function, and the Dual Play Menu may be manually or automatically closed at step 616.

B. Initiating a Second, Different Game

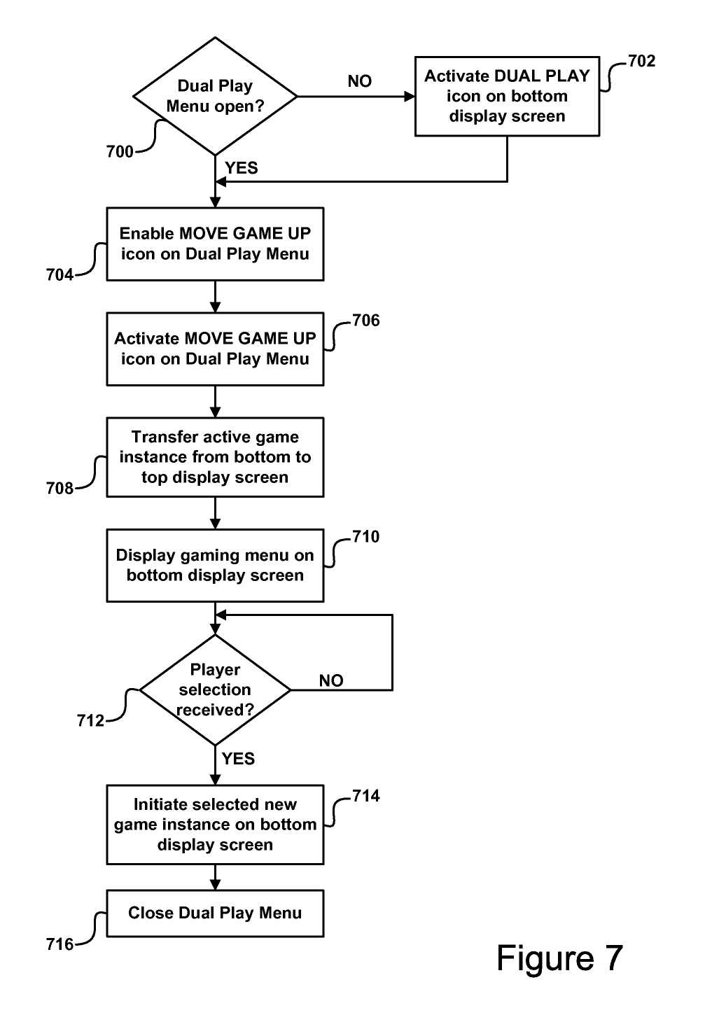

With reference to FIG. 7, steps for initiating, on the top display screen 112, an instance of a game different to the currently-active game on the bottom display screen 111 are indicated.

The procedure commences with opening the Dual Play Menu 206, if not already open, by activating the DUAL PLAY icon 204 on the bottom display screen 111, as indicated at steps 700 and 702. The MOVE GAME UP icon 304 is enabled on the Dual Play Menu at step 704. At step 706 the player activates the MOVE GAME UP icon which causes, at step 708, the instance of the currently-active game on the bottom display screen 111 to be transferred to the top display screen 112. A menu of available games is then presented on the bottom display screen 111, at step 710. The player selects a game from the menu of available games at step 712, and at step 714 an instance of the player-selected game is initiated on the bottom display screen 111. The Dual Play Menu 206 then may be manually or automatically closed, at step 716.

The player-selected game initiated on the bottom display screen 111 may be the same game that was transferred from the bottom display screen 111 to the top display screen 112. In such circumstances, the MOVE GAME UP icon 304 achieves the same result as the SAME AGAIN icon 300 of the Dual Play Menu 206.

C. Swapping Games in Dual Play Mode

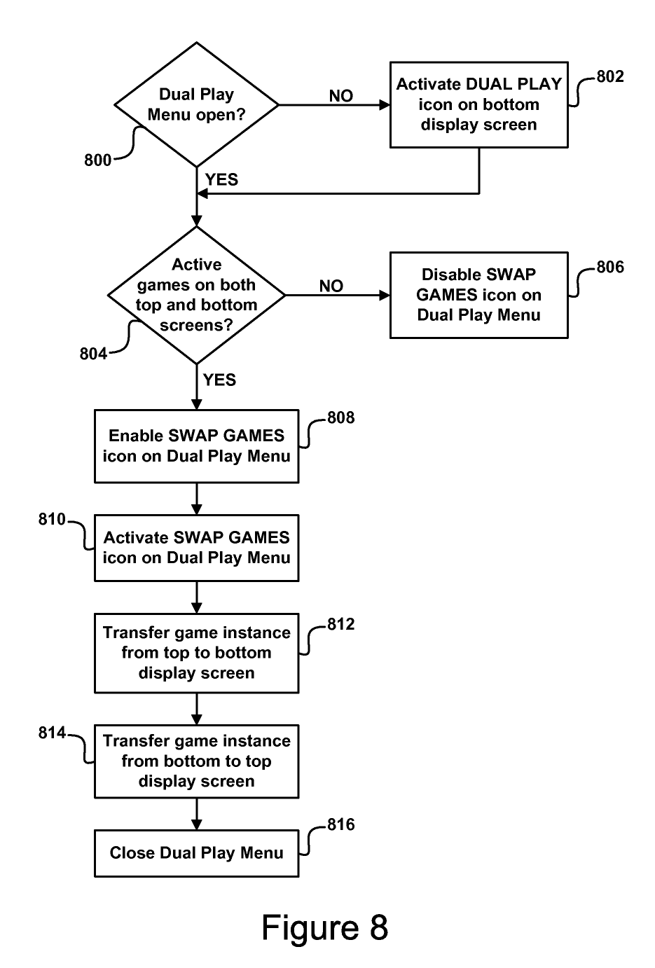

FIG. 8 represents a flow chart of steps for swapping currently-active game instances on the top and bottom display screens, 112 and 111, respectively. The currently-active games may be instances of different games or separate instances of the same game.

The procedure commences with opening the Dual Play Menu 206, if not already open, by activating the DUAL PLAY icon 204 on the bottom display screen 111, as indicated in steps 800 and 802. If, at step 804, there are active game instances on each of the top and bottom display screens 112 and 111, the SWAP GAMES icon 302 on the Dual Play Menu 206 is enabled, as reflected at step 808. On the other hand, if there is no game instance active on one of these display screens, the SWAP GAMES icon 302 on the Dual Play Menu 206 is disabled at step 806.

The player can activate the enabled SWAP GAMES icon 302 at step 810 to cause the currently-active game instance on the top display screen 112 to move to the bottom display screen 111 as illustrated at step 812 and, simultaneously, cause the currently-active game instance on the bottom display screen 111 to transfer to the top display screen 112 at step 814. The Dual Play Menu 206 may be manually or automatically closed at step 816.

D. Closing the Top Game

The player may terminate a currently-active game instance on the top display screen 112 by activating the CLOSE TOP GAME icon 306 on the Dual Display Menu 206. In response, the Dual Play Menu 206 closes automatically and the top display screen 112 will return to displaying artwork and/or promotional messages relating to the currently-active game instance on the bottom display screen 111. If there is no currently-active game instance on the top display screen 112, the CLOSE TOP GAME icon 306 on the Dual Display Menu 206 is disabled.

E. Closing the Dual Display Menu

The player may unconditionally force the Dual Play Menu 206 to close, if already open, by activating the CLOSE MENU icon 308 on the Dual Play Menu. Furthermore, the player may also close the Dual Play Menu by either activating the Dual Play icon 204 once more, or by touching the bottom display screen 111 outside the area occupied by the Dual Play Menu 206. The gaming machine 100 remains in dual game play mode.

F. Configuring Game Play

In an example embodiment, both top and bottom display screens 112, 111 are touch-sensitive display screens. In this embodiment, each active game instance has its own wager controls in the form icons that the player may utilise to regulate the progress of that game instance. With reference to FIG. 2, a representative, but non-limiting example of wager controls is described below. The particular design of the wager controls 202 is not considered important and can vary widely from those described in this section.

The wager controls for the game of FIG. 2 include a Coins icon 208, a Select Lines icon 210, a Bet Per Line icon 212, a Bet Max icon 214 and a Spin icon 216. The Coins icon 208 allows a player to vary the coin size used in wagering, for example 5 c, 10 c, 25 c, or $1 (currently set at $1). However, wagers supported by the Coins icon 208 can take on any non-negative value. The Select Lines icon 210 is used to select the number of active pay lines (currently set to 9) in the game which, in this example, is a video slot game. The Bet Per Line icon 212 allows the player to adjust the number of coins wagered per active pay line (currently set to 20). By toggling the Bet Per Line icon 212, the number of coins wagered per active pay line may increase by one coin, up to a maximum of 20 coins, after which the number of coins wagered per active pay line returns to 1 coin. The Bet Max icon 214 automatically results in a total wager of the maximum number of coins (here, 20 in this example) per active pay line. The Spin icon 216 initiates a turn of the game by causing the symbols of the video slot game to spin (simulated) and to come to rest in a new, randomly-generated arrangement.

The player controls the game instance on the bottom display screen 111 by means of the wager controls 202 displayed on the bottom display screen, and controls the game instance on the top display screen 112 by means of the wager controls 202 displayed on the top display screen. Furthermore, the gaming machine 100 may be equipped with a console (not shown) having physical buttons that perform the functions of some or all of the wager controls described above. The console buttons can be used in parallel with the wager controls 202 to regulate the progress of the active game instance on the bottom display screen 111, but have no effect on the active game instance on the top display screen 112.

In a gaming machine, such as that described herein in which the top and bottom display screens are in vertical alignment, it may not be ergonomically feasible to use wager controls 202 on the top display screen 112 to regulate the progress of the game instance on the top display screen.

In order to overcome this deficiency, an alternative embodiment provides for wager controls (and the console buttons) to operate only in conjunction with the active game instance on the bottom display screen 111. In this embodiment, operating parameters of the active game instance on the bottom display screen 111 are configured in the same manner as described above using the wager controls (i.e. Coins icon 208, Select Lines icon 210, Bet Per Line icon 212 and Max Bet icon 214) on the bottom display screen 111, or by means of the console buttons. The corresponding wager controls of the game instance on the top display screen 112 are disabled, in which case the top display screen 112 need not be a touch-sensitive display screen. In order to configure the operating parameters of the active game instance on the top display screen 112, the game instances on the top and bottom display screens 112, 111 are first swapped using the SWAP GAMES icon 302 of the Dual Play Menu 206 in order to bring the top game instance into focus on the bottom display screen 111. At this stage, the game instance on the bottom display screen 111 (and which was formerly on the top display screen 112) can be configured using the wager controls 202 of this game instance, or by means of the console buttons.

G. Controlling Game Play

The player activates the Spin icon 216 of the wager controls 202 in order to initiate a turn of an active game instance. Referring to the previously-described embodiment of the gaming machine 100 in which both top and bottom display screens 112, 111 are touch-sensitive, turns of active game instances on both display screens may be initiated asynchronously by activating the respective Spin icons 216 of the respective wager controls 202. In the alternative embodiment in which the top display screen is not touch-sensitive, activation of the Spin icon 216 of the wager controls 202 on the bottom display screen 111 may initiate a turn of the active game instance on each of the top and bottom display screens 112, 111, causing such turns to occur synchronously. As described above, the game instances on the top and bottom display screens 112, 111 can be two separate instances of the same game or instances of each of two different games.

The wager controls 202 shown in FIG. 2 include, further, an Autoplay icon 220. Activation of the Autoplay icon 220 causes supplementary icons (not shown) to be displayed for configuring additional game operating parameters. In particular, the player is able to configure the game instance to complete a plurality of consecutive turns of the game autonomously, without further intervention from the player. In particular, the player can configure the size of a wager to be applied uniformly to each consecutive turn of the game, and can then select a desired number of consecutive turns of the game that are to be played further intervention.

In the embodiment in which both top and bottom display screens 112, 111 are touch-sensitive, the player may configure either one or both of the active game instances for autonomous play as described. Autonomous play of a configured game instance commences when the player activates the Spin icon 216 of the wager controls 202 corresponding to that game instance, and continues for the configured number of consecutive turns of the game, independently of play of the other game instance.

In the alternative embodiment in which the top display screen is not touch-sensitive, the player configures a game instance on the bottom display screen 111 for autonomous play as described above. The player can then move the configured game instance to the top display screen 112 (by using the SAME AGAIN icon 300, the SWAP GAMES icon 302 or the MOVE GAME UP icon 304 as necessary). When the player next activates the Spin icon 216 on the wager controls 202 on the bottom display screen 111, autonomous play of the configured game instance initiates on the top display screen 112 and continues for the configured number of consecutive turns of the game, independently of play of any active game instance on the bottom display screen 111.

The player may also configure a game instance on the bottom display screen for autonomous play, in which case activation of the Spin icon 216 initiates autonomous play of both game instances, independently of one another.

As an alternative example, autonomous play of a configured (but still idle) game instance may initiate automatically upon transfer of that game instance from the bottom display screen 111 to the top display screen 112.

### IV. Example Operations

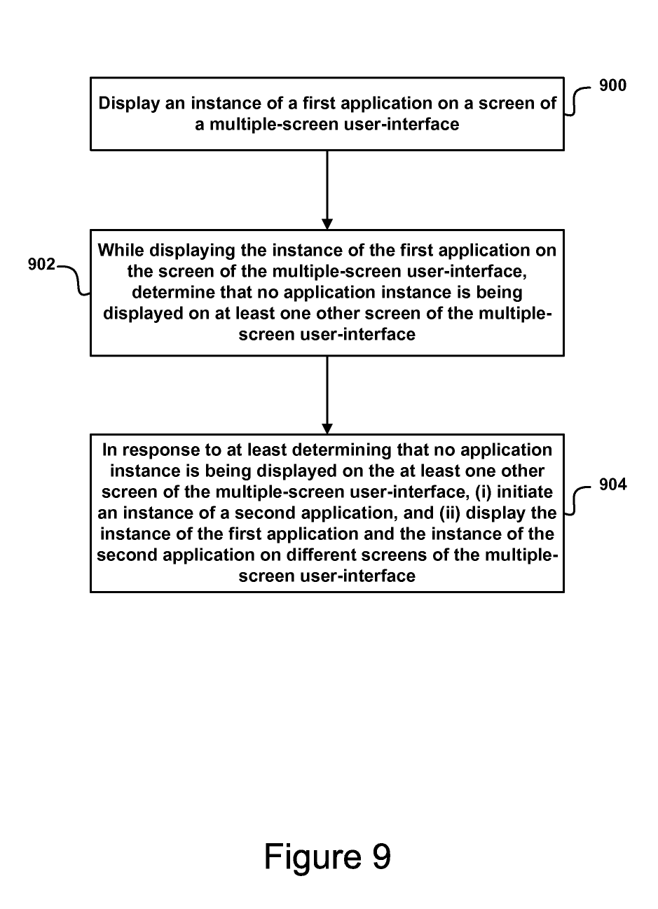

FIG. 9 is a flow chart that depicts an example operation. At block 900, an instance of a first application may be displayed on a screen of a multiple-screen user-interface. At block 902, perhaps while displaying the instance of the first application on the screen of the multiple-screen user-interface, it may be determined that no application instance is being displayed on at least one other screen of the multiple-screen user-interface. At block 904, potentially in response to at least determining that no application instance is being displayed on the at least one other screen of the multiple-screen user-interface, (i) an instance of a second application may be initiated, and (ii) the instance of the first application and the instance of the second application may be displayed on different screens of the multiple-screen user-interface.

In some embodiments, the first and second applications are the same application, while in other embodiments the first and second applications are different applications. Regardless, the first and second applications may operate independently from one another.

Displaying the instance of the first application on a first screen and displaying the instance of the second application on a second screen may involve swapping application instances and screens so that the instance of the first application is displayed on the second screen and the instance of the second application is displayed on the first screen. In some embodiments, the multiple-screen user-interface may include a swap-screen control, and the application instances and screens may be swapped also in response to determining that the swap-screen control has been activated.

Alternatively or additionally, the instance of the first application may be displayed on a first screen. Displaying the instance of the first application and the instance of the second application on different screens of the multiple-screen user-interface may involve moving the display of the instance of the first application to a second screen, and displaying the instance of the second application on the first screen. In some embodiments, the multiple-screen user-interface may include a move control, and the display of the instance of the first application may be moved to the second screen in response to determining that the move control has been activated.

Generally speaking, each respective screen of the multiple-screen user-interface may be associated with a respective set of controls that impact behavior of the respective application displayed on the respective screen. Alternatively, a single screen of the multiple-screen user-interface may be associated with a set of controls that only impact behavior of an application displayed on the single screen, or a single screen of the multiple-screen user-interface may be associated with a set of controls that impact behavior of applications displayed on any screen of the multiple-screen user-interface.

In some embodiments, a given screen of the multiple-screen user-interface may be associated with an autoplay control. Operating the first application may involve performing a first sequence of turns with each turn in the first sequence performed according to a first parameter. If it is determined that the autoplay control has been activated for the first application, a specification of a first number of turns and a specification the first parameter may be received. The first application may be automatically performed for the first number of turns, such that each respective turn is performed according to the first parameter.

Additionally, operating the second application may involve performing a second sequence of turns with each turn in the second sequence performed according to a second parameter. If it is determined that the autoplay control has been activated for the second application, a specification of a second number of turns and a specification the second parameter may be received. The second application may be automatically performed for the second number of turns, such that each respective turn is performed according to the second parameter.

Further, performance of the second application for the second number of turns may begin before performance of the first application for the first number of turns ends.

Additionally, in any embodiment, the multiple-screen user-interface may be combined with a computing device so that the computing device comprises the multiple-screen user-interface. Alternatively, the multiple-screen user-interface and the computing device may be separate physical devices that communicate with one another (e.g., over a network). In either arrangement, the computing device may include a computer-readable medium containing instructions that, if executed, cause the computing device to perform any of the functions described above.

### V. Conclusion

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium such as a storage device including a disk or hard drive or other storage medium.

The computer-readable medium may also include non-transitory computer-readable media such as computer-readable media that stores data for short periods of time like register memory, processor cache, and random access memory (RAM). The computer-readable media may also include non-transitory computer-readable media that stores program code and/or data for longer periods of time, such as secondary or persistent long term storage, like read only memory (ROM), optical or magnetic disks, compact-disc read only memory (CD-ROM), for example. The computer-readable media may also be any other volatile or non-volatile storage systems. A computer-readable medium may be considered a computer-readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

For the embodiments described herein, the terms “random” or “randomly” shall refer to any realizable process of randomly generating events. Such processes shall include, but not be limited to, generating events without a deterministic pattern of occurrences. Additionally, these processes may be pseudo-random, thus resulting in a deterministic pattern of occurrences that exhibit some form of statistical randomness.

It should also be understood that use of any form of enumeration within an element of any of the claims should not be construed to imply that an ordering of events within the claim is required.

A portion of the disclosure of this patent document contains material which is subject to copyright protection. The copyright owner has no objection to the facsimile reproduction by anyone of the patent document or patent disclosure, as it appears in the Patent Office file or records, but otherwise reserves all copyright rights whatsoever.

Furthermore, other variations from the disclosed embodiments may be made without departure from the scope of the invention. All questions concerning scope are to be answered by reference to the appended claims.

What is claimed is:

1. A method comprising:
displaying an instance of a first application on a screen of a multiple-screen user-interface;
while displaying the instance of the first application on the screen of the multiple-screen user-interface, a computing device determining that no application instance is being displayed on at least one other screen of the multiple-screen user-interface; and
in response to at least determining that no application instance is being displayed on the at least one other screen of the multiple-screen user-interface, (i) the computing device initiating an instance of a second application, and (ii) the multiple-screen user-interface displaying the instance of the first application and the instance of the second application on different screens of the multiple-screen user-interface.

2. The method of claim 1, wherein the first and second applications are the same application.

3. The method of claim 1, wherein the first and second applications are different applications.

4. The method of claim 1, wherein the first and second applications operate independently from one another.

5. The method of claim 1, wherein the instance of the first application is displayed on a first screen and the instance of the second application is displayed on a second screen, the method further comprising:
the computing device swapping application instances and screens so that the instance of the first application is displayed on the second screen and the instance of the second application is displayed on the first screen.

6. The method of claim 5, wherein the multiple-screen user-interface includes a swap-screen control, the method further comprising:
the computing device determining that the swap-screen control has been activated, wherein the computing device swaps the application instances and screens also in response to determining that the swap-screen control has been activated.

7. The method of claim 1, wherein the instance of the first application is displayed on a first screen, and wherein displaying the instance of the first application and the instance of the second application on different screens of the multiple-screen user-interface comprises:
moving the display of the instance of the first application to a second screen; and
displaying the instance of the second application on the first screen.

8. The method of claim 7, wherein the multiple-screen user-interface includes a move control, the method further comprising:
the computing device determining that the move control has been activated, wherein the computing device moves the display of the instance of the first application to the second screen in response to determining that the move control has been activated.

9. The method of claim 1, wherein each respective screen of the multiple-screen user-interface is associated with a respective set of controls that impact behavior of the respective application displayed on the respective screen.

10. The method of claim 1, wherein a single screen of the multiple-screen user-interface is associated with a set of controls that only impact behavior of an application displayed on the single screen.

11. The method of claim 1, wherein a given screen of the multiple-screen user-interface is associated with a set of controls that impact behavior of applications displayed on any screen of the multiple-screen user-interface.

12. The method of claim 1, wherein a given screen of the multiple-screen user-interface is associated with an autoplay control, and wherein operating the first application comprises performing a first sequence of turns with each turn in the first sequence performed according to a first parameter, the method further comprising:
the computing device determining that the autoplay control has been activated for the first application;
the computing device receiving (i) a specification of a first number of turns, and (ii) a specification the first parameter; and
the computing device automatically performing the first application for the first number of turns, wherein each respective turn is performed according to the first parameter.

13. The method of claim 12, wherein operating the second application comprises performing a second sequence of turns with each turn in the second sequence performed according to a second parameter, the method further comprising:
the computing device determining that the autoplay control has been activated for the second application;
the computing device receiving (i) a specification of a second number of turns, and (ii) a specification the second parameter; and
the computing device automatically performing the second application for the second number of turns, wherein each respective turn is performed according to the second parameter.

14. The method of claim 13, wherein performance of the second application for the second number of turns begins before performance of the first application for the first number of turns ends.

15. The method of claim 1, wherein the computing device comprises the multiple-screen user-interface.

16. A computing device comprising:
a multiple-screen user-interface;
a processor; and
data storage containing program instructions, that upon execution by the processor, cause the computing device to perform operations comprising (i) displaying an instance of a first application on a screen of the multiple-screen user-interface, (ii) while displaying the instance of the first application on the screen of the multiple-screen user-interface, determining that no application instance is being displayed on at least one other screen of the multiple-screen user-interface, and (iii) in response to at least determining that no application instance is being displayed on the at least one other screen of the multiple-screen user-interface, (a) initiating an instance of a second application, and (b) displaying the instance of the first application and the instance of the second application on different screens of the multiple-screen user-interface.

17. An article of manufacture including a non-transitory computer-readable medium, having stored thereon program instructions that, upon execution by a server device, cause the server device to perform operations comprising:
displaying an instance of a first application on a screen of a multiple-screen user-interface;
while displaying the instance of the first application on the screen of the multiple-screen user-interface, determining that no application instance is being displayed on at least one other screen of the multiple-screen user-interface; and
in response to at least determining that no application instance is being displayed on the at least one other screen of the multiple-screen user-interface, (i) initiating an instance of a second application, and (ii) displaying the instance of the first application and the instance of the second application on different screens of the multiple-screen user-interface.

18. A gaming machine comprising:
a first screen on which the gaming machine is configured to display a first game;
a second screen; and
a first control configured to instigate a turn of the first game, wherein the gaming machine is configured to (i) display a second game on the second screen simultaneously with the first game being displayed on the first screen, (ii) in response to a request, provide a second control configured to instigate display of the second game on the second screen, and provide a third control to instigate a turn of the second game.

19. The gaming machine of claim 18, wherein the gaming machine is configured to provide a common control which is configured to serve as both the first control and the third control.

20. The gaming machine of claim 19, wherein the gaming machine is configured such that the common control instigates a turn of the first game if the first game is displayed on the first screen, and instigates a turn of the second game if the second game is displayed on the first screen.

21. The gaming machine of claim 20, wherein the gaming machine is configured to provide a fourth control such that when the first game is displayed on the first screen and the second game is displayed on the second screen, operation of the fourth control is configured to cause the games to swap such that the second game is displayed on the first screen and the first game is displayed on the second screen.

22. The gaming machine of claim 21, wherein the gaming machine is configured to provide a fifth control configured to instigate autoplay of whichever of the first game and the second game is displayed on the first screen so that the gaming machine will perform multiple turns of that game without user initiation of each of the multiple turns.

23. The gaming machine of claim 22, wherein the gaming machine is configured such that when autoplay has been instigated for one of the first and second games displayed on the first screen, the fourth control is configured to swap the games so that autoplay of the one of the first and second games is displayed on the second screen and the other of the first and second games is displayed on the first screen.

24. The gaming machine of claim 23, wherein the gaming machine is configured such that when the fourth control has been operated to swap the games so that the other of the first and second games is displayed on the first screen, while autoplay of the one of the first and second games is being displayed on the second screen, (i) the first control is configured to instigate one or more turns of the other of the first and second games on the first screen or (ii) the fifth control is configured to instigate autoplay of the other of the first and second games on the first screen.
